(19) United States
(12) Patent Application Publication
(10) Pub. No.: US 2003/0231190 A1
(43) Pub. Date: Dec. 18, 2003

(54) Methods and systems for downloading and viewing maps

(76) Inventors: Bjorn Jawerth, Morrisville, NC (US); Do Hyun Chung, Raleigh, NC (US); Prasanjit Panda, Apex, NC (US); Johan Rade, Cary, NC (US); Jiangying Zhou, Cary, NC (US)

Correspondence Address: PENNIE AND EDMONDS, 1155 AVENUE OF THE AMERICAS, NEW YORK, NY, 100362711

(21) Appl. No.: 10/390,124

(22) Filed: Mar. 17, 2003

Related U.S. Application Data
(60) Provisional application No. 60/364,870, filed on Mar. 15, 2002.
(60) Provisional application No. 60/365,074, filed on Mar. 16, 2002.

(51) Int. Cl. G09G 5/00

(52) U.S. Cl. 345/660

(57) ABSTRACT

Embodiments of the present invention comprise a method for transmitting map data, a method for displaying map data, a system for processing and displaying map data, and a method for rendering line segments on a pixel display. A preferred method for transmitting map data comprises receiving, layering, and simplifying map data and transmitting some of the simplified data. A preferred method for displaying map data comprises receiving compressed map data, decompressing the received data, and rendering the decompressed data on a display device. A preferred system for processing and displaying map data comprises a map database, a map generation sub-system, a map rendering sub-system, and a display device. A preferred method for rendering line segments on a pixel display, comprises, for a line segment from a first endpoint to a second endpoint, rounding off the slope of the line segment and calculating pixel locations based on that rounded off slope.

### CROSS-REFERENCE TO RELATED APPLICATIONS

This application claims priority to U.S. provisional patent application No. 60/364,870, filed Mar. 15, 2002, and to U.S. provisional application No. 60/365,074, filed Mar. 16, 2002. The entire contents of each of the above two applications are incorporated herein by reference.

### BACKGROUND

Most mapping applications store raw map data on a server and then, in response to a request for the map of particular geographic location, create a bitmap image using the raw; map data and send the image to the client requesting the map. But this approach is not appropriate for mobile and wireless handheld devices (“handheld devices”), such as cell phones and Personal Digital Assistants (PDAs), because it requires sending a large amount of data for each new view of the map data.

For example, Internet sites that allow users to find a map, like MapQuest (see http://www.mapquest.com) and Yahoo! Maps (see http://maps.yahoo.com), typically generate a raster graphic image of the requested map, then transmit the entire image to the user's computer. If a user wishes to change the view, the server generates the new view and transmits the entire image again.

There are also programs that enable the display of maps on PDAs. One such program, Firepad's FireViewer (see http://www.firepad.com) is basically a raster image viewer with support for fast panning by dragging. The same company, Firepad, has, another application called FireConverter that converts existing images in popular formats (e.g., JPEG, TIFF, GIF, and BMP) into Firepad's own image format. Another PDA map application is HandMap™ (see http://www.handmap.net), which generates vector graphics maps and has support for pan and zoom. This application is targeted for devices running either Palm OS or Windows CE, and thus requires the use of a stylus. Another company, SpaceMachine (see http://www.spacemachine.net/) has a mapping program for Pocket PC-based PDAs called PocketMap™. Other mapping programs for PDAs can be found at CitiKey (see http://www.citikey.com/), CitySync (see http://www.citysync.com), and GeoView (see http:/Hdigitalearth.gsfc.nasa.gov/geoview).

In the cell-phone field, most of the mapping applications are from non-American companies. Navitime (see http://www.navitime.co jp/eng/open), for example, is a Japanese company that has a prototype system that generates vector graphics maps on BREW-enabled cell phones. Other Japanese companies that have mapping technology for cell phones are ZENRIN Co., Ltd (see http://www.zenrin.co jp/), CYBIRD Co., Ltd. (see http://www.cybrid.cojp) and K Laboratory Co., Ltd (see http://www.klabs.org/).

While most of the above mapping applications use raster images to display maps, some of them are based on vector-formatted data. But none of the above applications provide a method and system for transmitting, displaying, and panning and zooming maps that requires relatively small amounts of bandwidth, memory, and processing speed.

### SUMMARY

The present invention comprises a method and system for the generation of maps and for the subsequent downloading and viewing of maps on a handheld device. A preferred embodiment of the system of the invention is referred to herein as the BlueFuel™ Map system. Two file formats are preferably generated by this system—a compressed BlueFuel Map (BFM) format and an intermediate BlueFuel Map (BFMI) format. Preferred embodiments comprise a number of methods to select, layer, extract, simplify, encode, decode, and render maps on a wide range of handheld devices. A preferred Map Generation sub-system 110 operates using a method in which: (a) map data is selected; (b) layers are formed and extracted; (c) layers are simplified using both lossy and lossless techniques; and (d) lossless compression is applied to the simplified layers. Map files generated by the preferred Map Generation sub-system 110 are either in the BFM format or in the BFMI format. A preferred Map Rendering sub-system 120 operates using methods for real-time processing, efficient multi-layer rendering, pan and zoom, fast poly-line rendering, progressive text rendering, and/or text de-cluttering. See FIG. 1.

As discussed above, most mapping applications store raw map data on a server, and then, in response to a request for the map of particular geographic location, create a bitmap image using the raw map data and send the image to the client requesting the map. This approach is not appropriate for handheld devices because it requires sending a large amount of data for each new view of the map data. The BlueFuel Map systems and methods described herein are based upon a very different approach that uses vector-formatted map data and involves layering the map data, simplifying the layered map data, coding the simplified map data, transmitting and decoding the coded map data, and rendering the decoded map data. Instead of directly coding the simplified data, these systems and methods provide the option of packing the simplified map data prior to coding it. Since the map data is in a vector format (versus a raster format), panning and zooming of the map data are inherently supported by the systems and methods.

Embodiments of the present invention comprise a method for transmitting map data, a method for displaying map data, a system for processing and displaying map data, and a method for rendering line segments on a pixel display. A preferred method for transmitting map data comprises receiving, layering, and simplifying map data and transmitting some of the simplified data. A preferred method for displaying map data comprises receiving compressed map data, decompressing the received data, and rendering the decompressed data on a display device. A preferred system for processing and displaying map data comprises a map database, a map generation sub-system, a map rendering sub-system, and a display device. A preferred method for rendering line segments on a pixel display comprises, for a line segment from a first endpoint to a second endpoint, rounding off the slope of the line segment and calculating pixel locations based on that rounded off slope.

### BRIEF DESCRIPTION OF THE DRAWINGS

FIG. 1 depicts preferred components of a preferred embodiment of the present invention.

FIG. 2 depicts overall structure of a preferred map generation method of the present invention.

FIG. 3 illustrates a Bluefuel text compression method used in a preferred embodiment of the present invention.

FIG. 4 illustrates pan and zoom features of a preferred map rendering subsystem.

FIG. 5 depicts a preferred data structure used for map poly-line data.

FIG. 6 illustrates an exemplary poly-line that intersects a view port at two points.

FIGS. 7-9 show a flowchart that describes steps of a preferred, poly-line rendering method.

FIG. 10 illustrates classification of line segments into four types.

FIG. 11 depicts steps of a preferred method for clipping and drawing a type 4 line segment.

FIG. 12 depicts examples of application of the method described in FIG. 11.

FIG. 13 shows exemplary fonts used in an implementation of a preferred map rendering sub-system designed for handheld phones.

FIG. 14 shows overall structure of one implementation of a preferred Bluefuel Map system with a preferred Data Processing sub-system.

FIG. 15 depicts a graphic representation of a road map, with junction nodes, end nodes, and shape nodes included.

FIG. 16 depicts the road map of FIG. 15 with only junction nodes and end nodes.

FIG. 17 shows the road map of FIG. 16 after Douglas-Peucker poly-line simplification.

### DETAILED DESCRIPTION OF PREFERRED EMBODIMENTS

In the following, we describe preferred embodiments of the systems and methods of the present invention. First, we describe the two file formats preferably generated by a preferred BlueFuel system, then we describe preferred components of the system. See FIG.

Preferred Map Formats

The BlueFuel Map system preferably generates two file formats that facilitate efficient transmission of map data to a handheld device. In preferred implementations of the system, the input map data is in the form of ESRI Shapefiles (see discussion below on the ESRI Shapefile Format for more details) for the selected region within the United States of America, for example. The BlueFuel Map System is not restricted to using ESRI Shapefiles as input and can easily use other vector-based map formats for the input map data. Preferably the input map data is in vector format. The two map data formats are used for different purposes. BFM is used to store losslessly compressed map data that can-be transmitted to an application running the preferred Map Rendering sub-system 120 (see discussion below on Map Rendering), which then renders the map data. BMFI is used to store packed map data in an intermediate format. The map data in the BFMI format can be converted to BFM and transmitted to an application running the Map Rendering sub-system 120.

The BlueFuel Map system supports a hierarchical storage of map data—that is, the map data preferably is divided into a hierarchy of layers. A base layer contains map data that constitutes the most basic information required by an application running the preferred Rendering sub-system 120. Typically, the base layer is compressed using the BFM format. Map data not contained in the base layer is stored in one or more detail layers. See the discussion below on Data Layering for more details on data layering and the formation of base and detail layers.

The first (BFM) format usually contains either the base layer (in one implementation of the BlueFuel Map system, this is the highway layer) or detailed map data for a limited map region (a section of the street layer for a metropolitan area, in the same implementation), and the second format (BFMI) usually contains detail layers for a relatively large map region (the street layer for an entire metropolitan area, in the same implementation). The main differences between the two formats are the amount of map data stored by the formats and whether or not the data is compressed. Note that the base layer defined by one implementation could contain no map data, in which case all the map data is part of the detail layers and (possibly) stored in BFMI format.

Preferred BFMI Format

A preferred BFMI format contains the information required by a preferred Map Rendering sub-system 120 to display detailed map data or a street layer for an entire metropolitan area in one implementation on a handheld device. Map data in BFMI format is packed but not compressed. The main purpose of a BFMI file is to create a compact representation of the detailed map data of a relatively large region. The file is preferably stored on the server and not transmitted to the handheld device. Storing the detail information in the BFMI format helps to minimize access time for the information once it is requested by a Map Rendering sub-system 120. In a preferred implementation, a format header includes the size of the header, file identifier, file type, total number of streets, total number of points and size of street name's buffer, number of names, and size of the dictionary. The rest of the format contains data stored for each street and, optionally, information about landmarks.

First, the number of points that compose the street poly-line structure, followed by the series of points, are stored, with each point being stored as two 16-bit numbers. This data is followed by the street's name, stored as a character array terminating with a new-line character. Finally, the street's score is stored in a single byte value. An optional mode exists that includes information about landmarks in the file format. The number of landmarks is stored in the file followed by the location information (two 16-bit numbers) of each landmark and the name (a series of characters terminated by a new-line) of each landmark. The order in which the data is coded (except for the format header) can be changed, as long as the Map Rendering sub-system 120 is made aware of the order in which the data is coded. For example, information related to the landmarks could precede information about the streets.

Preferred BFM format

The preferred BFM format contains essentially the same structure as the BFMI format, the main differences being that the map data contained in the BFM format is in a compressed format and typically corresponds to either the base layer or the detailed map data for a limited map region (in one implementation, corresponding to a highway layer or a section of a street layer for a metropolitan area, respectively).

A BFM file is compressed because it is transmitted to a handheld device (unlike a BFMI file). In a preferred implementation, three different compression routines compress highway poly-line structures, highway names, and highway scores, respectively. These compression schemes are discussed in detail below in the Compression section. Note that the landmark option is not supported by one embodiment of the BFM file format. Also, the format header includes fields that store values of parameters to the compression methods and thus are not part of the BFMI file header.

Components of a Preferred System

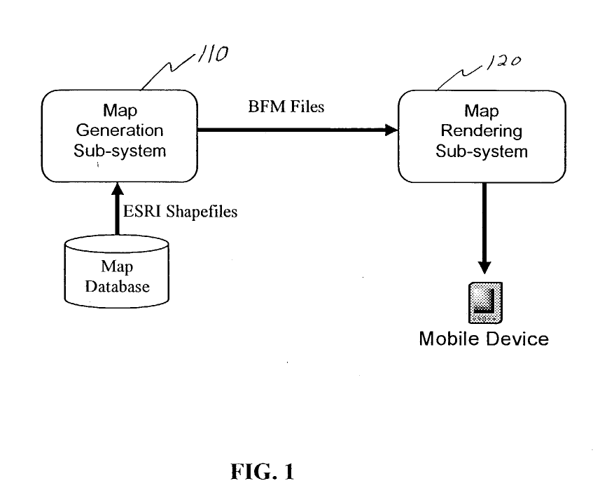

As discussed above, a preferred BlueFuel Map system comprises two sub-systems, shown in FIG. 1. A preferred-Map Generation sub-system 110 resides on a server and takes as input ESRI Shapefiles and generates BFM and BFMI files. A Map Rendering sub-system 120 resides on a handheld device and communicates-with the server to retrieve BFM files, which are then rendered on the handheld device. BFMI files preferably are never transmitted to the Map Rendering sub-system 120. These files preferably are used as intermediate files from which a BFM file for a section of the entire region covered by the BFMI is generated. While the Map Rendering sub-system 120 is preferably implemented on handheld devices, there is no limitation in the design that prevents the Map Rendering sub-system 120 from being implemented on other computing devices, including, but not limited to, laptop computers and personal computers.

Map Generation

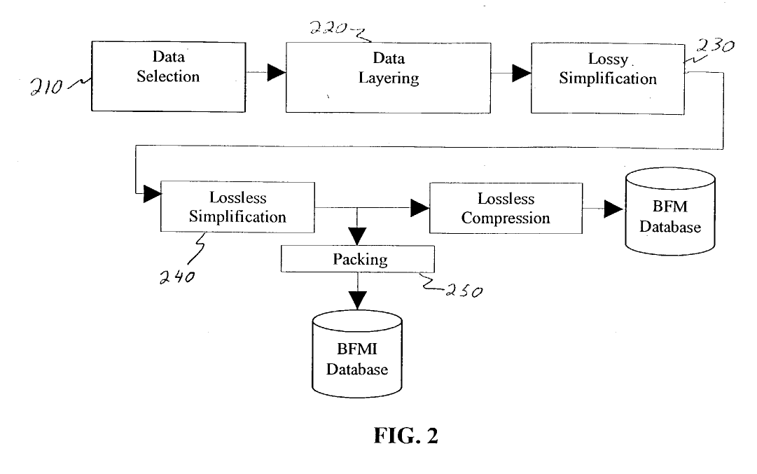

In order to provide map-based services on handheld devices, it is desirable to make data files as small as possible. Small file size is preferred on handheld devices due to the limited amount of memory available on such devices and the low bandwidth connections typically available to such devices. Given the large amount of raw map data and the challenge of generating a legible map on a handheld device, it is not an easy task to make the map not only simple and compact, but also useful. FIG. 2 shows overall structure of a preferred map generation process.

We describe herein how to generate compact map files that can be easily and quickly downloaded through a wireless communication channel. The input map files preferably are in the ESRI Shapefile format, which is presently the most popular file format for the Geographic Information Service community and are from the TIGER® (Topologically Integrated Geographic Encoding and Referencing) 2000 database (discussed below). The map database data preferably can be collected and processed in advance to enhance the response of the system's real time service; the process of creating the database is described below. In preferred implementations of the system of the present invention, all the necessary map data is from the TIGER® 2000 database, which is freely available to the public through the U.S. Census Bureau's web site, but-those skilled in the art will recognize that the system can easily be adapted to be compatible with other map data sources and file formats.

Data Selection

The preferred first step in the map generation process is to selectively extract map data from the TIGER® database. The map data to be extracted is typically determined by the characteristics of the device, including but not limited to the processing power, the memory size, and the display size, resolution, and pixel depth display. Another factor affecting the data selected is the intended usage of the BlueFuel Maps system. For example, a map that displays traffic information for only freeways and highways need not include any other roads.

In most cases, the desired characteristics for the application using the map data determine the type of map displayed as well as both the level of detail and the region covered by the map(s). For example, for a real-time traffic map application that uses the preferred technology, maps covering only major highways on a city-by-city basis are needed. For a particular city, a traffic information provider may have a set of speed sensors throughout the city; hence, the map only needs to cover the roads where the sensors are located. Accordingly, this first phase of a preferred Map Generation system and method, the Data Selection step 210 (see FIG. 2), comprises carefully choosing streets to be included in maps that will be displayed, and choosing the clipping range of the map for each designated location.

Data Layering

The selected map data is preferably then arranged into a hierarchy of layers. Layering of the data allows for flexibility in the information that is displayed. In the traditional approach, the data is stored in a layered format on the server, but the layers are merged prior to transmission. In the approach used in a preferred embodiment of the present invention, a layered structure is also used in transmission, so that the benefits of layering can be exploited on the display device. For example:

Layers that are no longer required are deleted from the display device to save memory, but layers that are likely to be required in the near future are retained.

The amount of data displayed changes as the user zooms and pans through the map data.

In general, ESRI Shapefiles contain a number of different types of map data, including line features like roads, railroads, hydrography, and transportation and utility lines; boundary features like statistical (census tracts and blocks), government (places and counties) and administrative (congressional and school districts); and landmark features like points (schools and churches), area (parks and cemeteries) and key geographic locations (apartment buildings and factories). There are a number of ways to define preferred layers using these different types of map data. One extreme is to include all the map data into one, layer. This type of layering results in an approach that is similar to prior art mapping applications that create a bitmap image of a-map on a server and transmit the image to a display device. Somewhere near the other extreme is creating a separate layer for each type of map data.

As stated above, a preferred BlueFuel Map system defines a base layer as a minimal set of map types needed by an application running the Map Rendering sub-system 120. A base layer could include all the available map types (some map types may have been discarded during Data Selection step 210) or none of the map types. Detail layers are preferably formed from map types not included in the base layer. More than one layer can be created from a single map type. What map types constitute the base layer-and detail layers, respectively, and how many data layers are used, are system parameters' specific to each individual implementation of a preferred embodiment.

For example, one preferred implementation uses three layers—highways, streets, and landmarks—but layers could comprise any appropriate information. Landmarks preferably are stored as co-ordinates with associated names. Highways and streets preferably are stored as poly-lines with associated names and scores. Poly-lines with higher-scores are displayed with higher priority, so that a zoom level can use a minimum score as a cut-off to avoid cluttering the display with too many streets and names. In another preferred implementation, two of the layers are freeways and highways.

Once the number of layers, the contents of each layer, and the region of the maps are determined, corresponding shape records for each layer are extracted from a map data source. In a preferred embodiment, the TIGER® 2000 database is used for the map data source. But other map data sources could be used instead without affecting the rest of the system and method. The only requirement is that the input to the next stage, the Lossy Simplification, must be in the same format. Map data from other sources is processed in a manner similar to the methods described regarding the Data Selection step 210 and Data Layering step 220 to achieve this goal. In one implementation, the Data Layering step 220 comprises searching for all occurrences of prescribed road names in the original TIGER® 2000 data (in text format) and generates a list of all the identifiers of the matched road segments. The road segments in the list are then collected together from the Shapefile version of TIGER 2000 data.

Lossy Simplification

As mentioned above, TIGER® 2000 Shapefiles contain all the details for a geographic region (for example, a city) down to the smallest street. Each poly-line in a Shapefile represents a street segment from one junction to another; the poly-lines preferably are sampled at a very high frequency to keep all the geometric details of street segments. A map covering a city might contain hundreds of street segments and each of those segments might contain tens of shape points. This degree of detail is unnecessary when the map is to be shown on the small screens of handheld handsets. It is better to simplify such maps, to achieve faster downloading and faster rendering on handheld devices.

Attributes associated with a road segment can be broken into three categories: (1) features attributes, (2) geometrical attributes, and topological attributes.

Features attributes include a road segment's name and classification; geometrical attributes include vertex coordinates and bounding-box coordinates; and topological attributes include intersection relationships between different roads. Since a road breaks into segments at intersections, topological attributes are represented implicitly in Shapefiles.

In a preferred Lossy Simplification step 230, topological and features attributes are maintained, and only geometrical attributes are modified. In other words, the goal of the Lossy Simplification step 230 is to remove unnecessary junctions by identifying consecutive poly-lines and merging them if they belong to the same street, as well as to simplify the shape by removing some shape points without drastically altering the shape. We will now describe Lossy Simplification as used in a preferred implementation of the invention. For more details, see Appendix C: Lossy Simplification Procedures.

Merging Two Layers

First, two lists of road names preferably are created: one for a highway layer and another for a street layer, using preferred Data Selection and Data Layering processes 210 and 220. Now, if the shape of each layer is altered independently, they may end up not matching each other. Therefore, the two layers are merged and then split up again in the final step (see discussion on Splitting to Two Layers).

Regularization

Since the two Shapefiles that are merged by collecting poly-lines are generated from multiple source Shapefiles, some information whose scope is local to the source file may have become invalid. Also, some of this information may be useful in subsequent processing, so it is better to correct these errors. For example, in original Shapefiles, all the starting and the ending nodes of the poly-lines are assigned a unique identifier. Unique identifiers are re-assigned to all the starting and ending nodes in the merged Shapefile.

Junction Detection

In order to keep the topology of the original map, junctions are identified and prevented from being changed during the Lossy Simplification process 230. In TIGER® 2000 data, all the starting and the ending nodes of the poly lines are either terminal nodes or junctions. However, since a relatively small number of streets are extracted from the source Shapefiles, not all the starting and the ending nodes are junctions in this Shapefile. Junctions are identified by comparing the starting and ending nodes of all the poly-lines. While identifying junctions, one can merge poly-lines if they share the same street name and one of the starting and the ending nodes.

Poly-Line Simplification

Now one can freely simplify the shape of each poly-line by removing some less important shape points. A preferred embodiment uses a published polygon simplification algorithm called the Douglas-Peucker algorithm (see http://geometryalgorithms.com/Archive/algorithm_{—}0205/algorithm 0205.htm and David Douglas & Thomas Peucker, “Algorithms for the reduction of the number of points required to represent a digitized line or its caricature,” The Canadian Cartographer 10(2), 112-122 (1973)) to perform this task.

Splitting to Two Layers

Once all the poly-lines are merged and simplified, they are split back into two layers.

Lossless Simplification

A preferred Lossless Simplification process 240 is applied to each of the layers. The poly-line data preferably is simplified by grouping together multiple road segments for the same road. Coordinate values of the points comprising the poly-lines are converted to a more precise co-ordinate system. Names of roads are preferably processed using standard abbreviation codes, to reduce the size of the road names. (Given the small dimensions of a handheld device, there is always a problem in rendering long text strings.) Finally, a numeric value, the score of a poly-line, is generated. This forms the basis for an algorithm to render road names based upon the importance of the road (see the section on Progressive Text Rendering). The score is independent of the layer at which the road is to be displayed. Steps in a preferred Lossless Simplification process include Clipping, Poly-line Grouping, Co-ordinate System Conversion, Name Processing, and Generate Scores.

Clipping

Given the effort and time required to accurately select the regions and the level of detail, to form the layers for the selected regions, and to simplify each layer using the lossy techniques described above, it is often advantageous to perform preferred Data Selection, Data Layering, and Lossy Simplification steps 210, 220, and 230 on large regions. In a preferred Clipping step, raw map data is clipped to a region around a city. For example, data for Wake County may be clipped from the USA map data to represent Raleigh, N.C.

Poly-Line Grouping

The first step in a preferred Poly-line Grouping step is to remove redundancies in poly-line data for chosen road layers. In traditional mapping applications, long roads are stored as a series of independent segments, to allow fast clipping of a specified region from the map database. A preferred BlueFuel Map application groups together adjacent segments with the same name into longer poly-lines. This approach has the advantage that poly-lines can be transmitted efficiently as vectors. Roads with no name, and ramps, are handled as special cases. Also, poly-lines with multiple parts are split into simple poly-lines with only one part, and poly-lines with no data are discarded. A special post-processing step may be applied that merges a road segment with a different name into a major road that encompasses the road segment.

Co-ordinate System Conversion

Each point in the poly-line data in a preferred shape file is stored using geometric co-ordinates as (latitude, longitude) pairs. Before poly-line grouping, each point preferably is converted from Geometric to UTM (Universal Transverse Mercator) co-ordinates. Conversion to UTM co-ordinates aligns the map data around a central meridian, the mid-longitude value for a layer. The Cartesian UTM co-ordinate system provides a square grid instead of a rectangular grid, providing a constant distance relationship anywhere in the map. There are no negative numbers or East-West designators and the co-ordinates are decimal-based and measured in metric units (see http://www.maptools.com/UsingUTM/whyUTM.html).

Name Processing

Road names are extracted from the database file associated with a Shapefile. Characters not supported by the system are processed out, and words are abbreviated using standard USPS abbreviation codes.

Generating Scores

After a preferred poly-line grouping process, a score is generated for each of the roads in a layer. The score is calculated as the sum of the L² distances between consecutive points in the street's poly-line. A special post-processing step may be applied in which small poly-lines with large scores are punished. This score is used in rendering of names of roads (see section on Progressive Text Rendering).

Packing

A preferred Packing process 250 can be applied to one or more of the simplified map layers in lieu of applying a preferred Compression process (see below). The data corresponding to the poly-lines, names, and scores is simply packed into an efficient binary format—the BlueFuel Map Intermediate (BFMI) format, described in the section entitled

Compression

Compression schemes used in a preferred embodiment are designed for fast and efficient decompression of map data on a handheld device that has a relatively slow processor and not much flash or RAM memory. Compression codes preferably are chosen so as to generate a nibble-aligned compressed file. Integer operations are favored instead of more complex floating-point operations. Thus, the compression methods are optimized for handheld devices. This does not mean that these algorithms are not valid for other machines (for example, laptops and personal computers). The values of parameters in these algorithms can easily be modified to increase the complexity of the algorithms (in terms of the amount of processing power and memory required) so that performance of the algorithms is enhanced for more powerful computing devices.

Compression of Poly-Lines

Poly-lines preferably are stored as a collection of points, with each point consisting of two numbers—the coordinates of the point. A simple compression scheme may be used, wherein each poly-line is encoded separately. First, the number of points is encoded using a byte-aligned code. The coordinates of the points in the poly-line are scaled, using a standard scaling method, to 16-bit precision. 16-bit precision is preferred because the poly-line data TIGER® database can be reconstructed without any loss of information with this precision, but in general the scaling factor can be adjusted to correspond to the precision of the input map data. A Differential Pulse Code Modulation (DPCM) coding scheme (see http://ce.sharif.edu/˜m_amiri/Projects/MWIPC/dpcm1.htm) is preferably used. A typical DPCM encoder (see FIG. 1: DPCM Encoder, at http://ce.sharif.edu/˜m_amiri/Projects/MWIPC/dpcm1.htm) consists of a quantization method, a prediction scheme, and an entropy encoder. Scalar quantization with 16-bit precision (as described above) is used in a preferred embodiment; a linear prediction scheme and the values generated by the prediction scheme are preferably encoded using nibble-aligned Pseudo-Huffman Codes.

Compression of Names

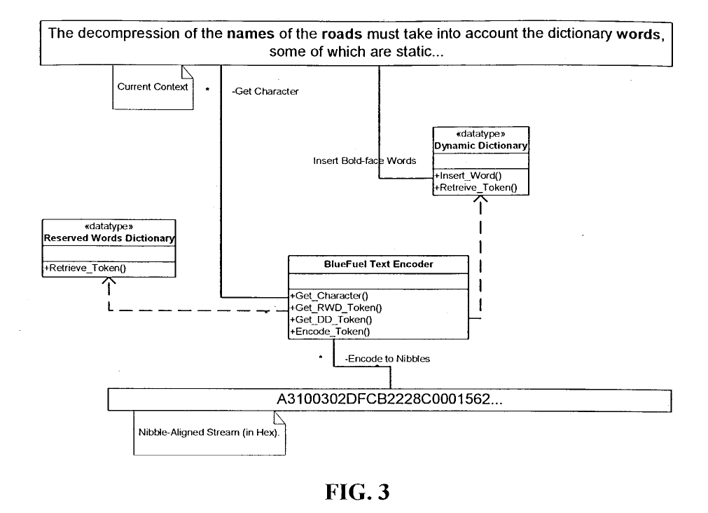

The name of the road is a field attached to each road in each map layer. A new and unique lossless text compression scheme based on the principles of the Lempel-Ziv text compression algorithm (see Mark Nelson and Jeanloup Gailly, “The Data Compression Book,” 2nd Edition, M & T Books; New York, N.Y.; 1995) is preferably used to compress the names of roads. Furthermore, the codes generated by the compression scheme are byte-aligned. These names are first pre-processed in the Name Processing step of the Lossless Simplification process. Also, a table containing the most common words found in road names is generated. The table preferably contains a static part that contains words like “RAMP” and “RD”, where “RD” is the abbreviation for “ROAD”, and a dynamic part that is generated from the actual data. See FIG. 3.

Compression of Scores

The scores for a layer preferably are first normalized to 8-bit precision, so that a maximum score takes the value 255 and a minimum score takes the value 0, and then stored in consecutive bytes.

Map Rendering

At the completion of preferred Map Generation sub-system processing, input map data has been converted to either the BFM format, the BFMI format, or both. A preferred Map Rendering sub-system 120 typically resides on a handheld device, though it is not restricted to handheld devices only and can run on other devices, such as laptop computers and personal computers. During the execution of an application based on the Map Rendering sub-system 120, a request may be sent for map data to a server containing the BFMJBFMI files. If the requested map data is already in BFM format, then the data is simply transmitted to the requesting device without any further processing. On the other hand, if the map data is stored in BFMI format, the data must first be compressed into BFM format before being transmitted to the requesting device. This extra processing preferably is done on the server in real-time by a Real-time Processing Module. This module is described below.

The division of the data into BFMIBFMI format is exploited at this stage of the preferred method. Instead of having to transmit a large file with all the map data compressed together as a single BFM file, separate layers are stored as BFM and BFMI files. A base layer is usually stored in the BFM file and requested by the application before the data in the BFM file. In this way, the division of map data into layers allows a more efficient transmission of map data, and allows map data to be transmitted only when requested (“on-demand”).

Once the map data is received by the application running a preferred Map-Rendering sub-system 120, it is decompressed. The decompression process entails decompression of poly-lines, names, and scores—corresponding to the compression processes for these three data types described in the section herein on Compression. After the map data has been decompressed by the application, it preferably is rendered using processes described in the sections herein following the section on Decompression, including Efficient Multi-Layer Rendering, Panning and Zooming, Fast Poly-line Rendering, Rendering the Text Layer, Text De-cluttering, Landmark Overlays, and Navigation of Highlights. One feature of the Map Rendering sub-system 120 stems from the multi-layer rendering concept: the order in which data layers are decompressed and rendered is independent of the layers, and can be changed from one implementation to another.

Real-Time Processing

The BFMI format section is used to store packed but uncompressed map data pertaining to a geographical region. For example, a BFMI file could contain the map data pertaining to the streets of the New York metropolitan area. When an application running a preferred Map-Rendering sub-system 120 requests a server with the BFMI files for map data, a preferred Real-time Process first loads the relevant BFMI map data into pre-defined data structures. Then, the Real-time Process may clip the map data if the region requested is smaller than that stored in the BFMI file. The clipped map data is then compressed (using techniques described in the section herein on Compression) and transmitted to the requesting device.

Decompression

For the most part, the preferred decompression process involves inverting the lossless compression performed during a preferred Map Generation process and filling appropriate data structures with the decoded information. Since preferred users for the BlueFuel Map system and in particular, the BlueFuel Map Rendering sub-system 120 are users of handheld devices, the entire BFM map may not be decompressed at one time, due to limitations imposed by the amount of memory available on the handheld device. The decompression techniques of a preferred embodiment must work both with and without the limitation of a fixed-size data buffer.

Decompression of Poly-Lines

Once BFM file header information is read and verified, poly-lines are decoded. For each poly-line, the number of points in the poly-line is first decoded. Then, for each point, the codes for the two co-ordinates are decoded into two 16-bit-precision numbers, using the inverse of the chosen DPCM method. The DPCM method is chosen such that implementation of the decompression method can be optimized using integer operations and multiplication/division operations are mostly with numbers to the power of 2. The specification DPCM method is chosen since it is efficient to implement on handheld devices; if more computational power and memory is available to the decompression process, a different DPCM method can be used.

Decompression of Names

The basic component of a preferred decompression method for names is based on principles of the Lempel-Ziv text compression method. The preferred method uses byte-aligned codes to create a fast decoding scheme, and the output from the scheme is a token of streams. These tokens require additional processing before they can be inserted into their proper positions in the list of names of roads. The additional processing includes replacing tokens that have entries in the dictionary with their values in the dictionary, inserting context-specific dictionary entries into the dictionary, handling the rules for upper- and lower-case letters, and combining the tokens into road names. The decompression of the names of the roads must take into account the dictionary words, some of which are static and are thus known to both the Map Generation and Map Rendering sub-systems, and some of which are dynamically created or context-specific dictionary words. These words are created for each BFM file and added to the dictionary as they are decoded by the decompression routine. Further complications arise from the facts that tokens decoded by the decompression method are part of a road name, and the decompression routine must be able to detect when a road name is completed (when a token is the last token for a road name). While naive methods are available to solve both problems, a preferred decompression routine uses a solution that minimizes both the number of bits added to the token stream and the decoding time overhead required to process this, extra information. Special symbols that flag these conditions are inserted into the code stream. Also, the preferred decoding algorithm uses knowledge of the set of tokens supported by the system to determine whether the token carries additional information, such as that it is the end of road name.

Decompression of Scores

A preferred decompression method for the scores comprises reading single byte numbers and storing them as scores for corresponding roads.

Efficient Multi-Layer Rendering

A preferred BlueFuel™ Map Rendering sub-system 120 simultaneously displays multiple layers of information (e.g., a street map layer, a highway map layer, shaded text, and landmarks). The desired priority order of each layer can vary from application to application. One approach is to render each layer on the same raster image buffer sequentially. This approach is easy-to implement, but very slow because it requires scanning the data several times.

If one tries to render multiple layers together using the same image buffer, some data from a higher layer will likely be corrupted by data from a lower layer. A preferred Map Rendering sub-system 120 divides a given 8 bit raster image buffer into multiple bit-planes, and renders each layer onto its allotted bit-plane. In the final step, each bit-plane is assigned a color, and then each pixel of the raster image is assigned the corresponding color of the highest bit that is set to one. This way, for example, road names can be drawn at the same time as a corresponding road.

TABLE 1

| Bit position | No of bits | No of colors | Data |
|---|---|---|---|
| 7 | 1 | 1 | Text |
| 6 | 1 | 1 | Shade of text |
| 5˜2 | 4 | 15 | Landmarks |
| 1 | 1 | 1 | Highway map |
| 0 | 1 | 1 | Street map |

Table 1 shows bit-plane allotment in one implementation of a preferred BlueFuel Map Rendering sub-system 120. The highest two bit-planes handle the text, the next 4 bits handle overlay landmarks, and the last two bit-planes handle the highway map and the street map data, respectively. Note that by assigning multiple bits to overlay landmarks, one can use more colorful landmark symbols. In this setup, the map can use up to 20 colors, including the background color.

Although this method imposes some restriction in the use of colors, it makes vector rendering very efficient: text, its shade, and street poly-lines can be drawn simultaneously. Furthermore, any drawing routine can be called in any order. In a preferred embodiment, street maps and street names (text and its shade) are drawn first, highway maps and highway names (text and its shade) are drawn next, overlay landmarks are drawn, and finally the raster image buffer is converted into a colored bitmap. Note that the order of these drawing procedures does not matter, except for the final color conversion.

Panning and Zooming

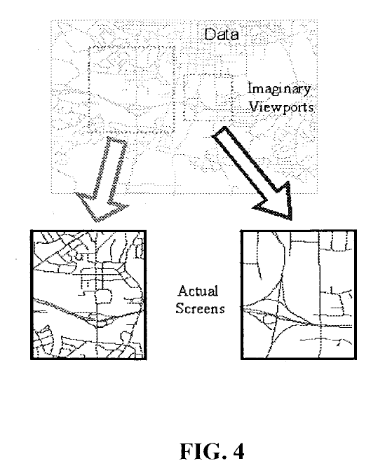

In order to draw vector data correctly on the screen, it is important to first find a proper scaling factor between the data coordinate system and the screen coordinate system. Determination of a scaling factor is largely based on whether the entire contents of the data are to be shown on the screen or just a portion, and if a portion, which portion. The scaling factor preferably is determined by a linear transformation between a bounding box of the data to be drawn and the actual screen. This provides zooming and panning capability (see FIG. 4).

Fast Poly-Line Rendering

A preferred embodiment of the present invention comprises a unique poly-line rendering method. This vector-based poly-line rendering method preferably processes a poly-line one line segment at a time, classifying each line segment into one of four line segment types. Determination of whether to draw and clip a line segment depends on its type. The preferred algorithm maintains a memory of the previous line segment (if applicable), to enhance the speed of the decision making process. Furthermore, a new line drawing algorithm, used by the preferred rendering method, has been optimized to take advantage of the relatively small display size of handheld devices.

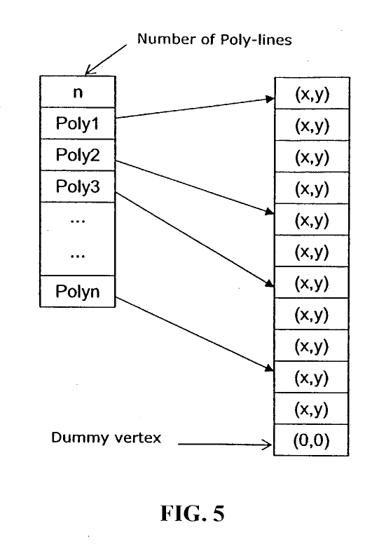

A vector-based poly-line rendering routine of a preferred Map Rendering sub-system 120 is very fast and efficient, largely due to compact and efficient map data structures and an optimized poly-line rendering routine. The preferred data structure comprises the number of poly-lines (a 16 bit integer), pointers to the first vertex of each poly-line (an array of 32 bit pointers), and an array of points or vertices, where each point is composed of two 16-bit integers corresponding to the x and y coordinates of the point. There is preferably a dummy vertex at the end of the data block, used to detect the end of 110 the vertex list. See FIG. 5.

When the preferred rendering routine begins, it scans through the vertex list and tries to classify each line segment into one of four types of line segments, by processing each vertex one at a time. To do this, the rendering routine checks the coordinates of each vertex against the four sides of the view port on the display screen. However, since consecutive vertices will most likely lie in the same region, most of the time one only needs to check whether the new vertex lies to the same side of the view port as the previous vertex.

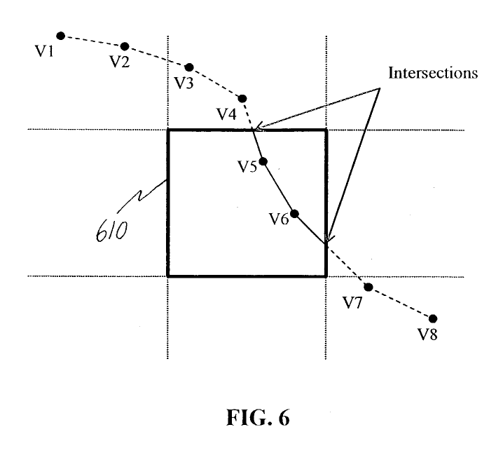

FIG. 6 depicts a typical poly-line that intersects at two points with a view port 610. In this example, the previous vertex (V1) is to the left of the view port 610, so it is quite likely that the next vertex (V2) also lies to the left of the view port 610. The preferred rendering routine can expedite this screening-process by checking whether the new vertex is also left of the view port 610. If so, the, routine simply moves to the next vertex (V3) and checks whether the same condition is true. When it reaches a vertex that does not lie to the left of the view port 610, (V3), the rendering routine checks the next condition, that is, is the vertex above the view port 610? If so, the routine proceeds in a similar manner. Otherwise, it checks the next condition, and so forth.

Once the rendering routine finds a vertex (V5) that satisfies all four boundary conditions and it knows that the current poly-line is inside the view port 610, the routine starts drawing poly-lines. Note that, up to this point, there was no need to keep track of which poly-line the routine was processing. The routine only needs to mind the poly-line boundaries to avoid connecting disjoint poly-lines. This is another advantage that leads to an increase in the speed of the screening process. Since the map data structure contains pointers to the first vertex of each poly-line, the routine can quickly synchronize whenever it is necessary.

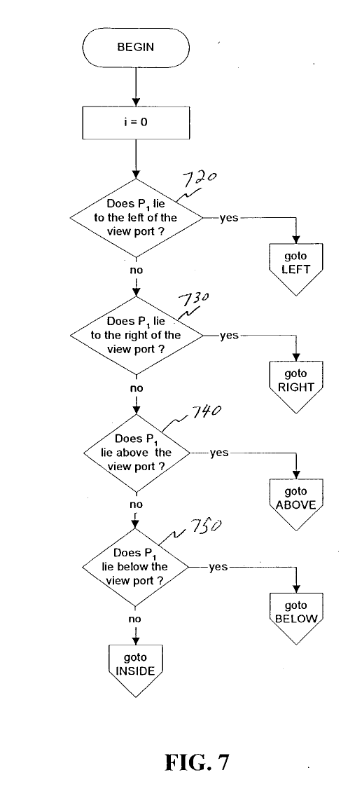

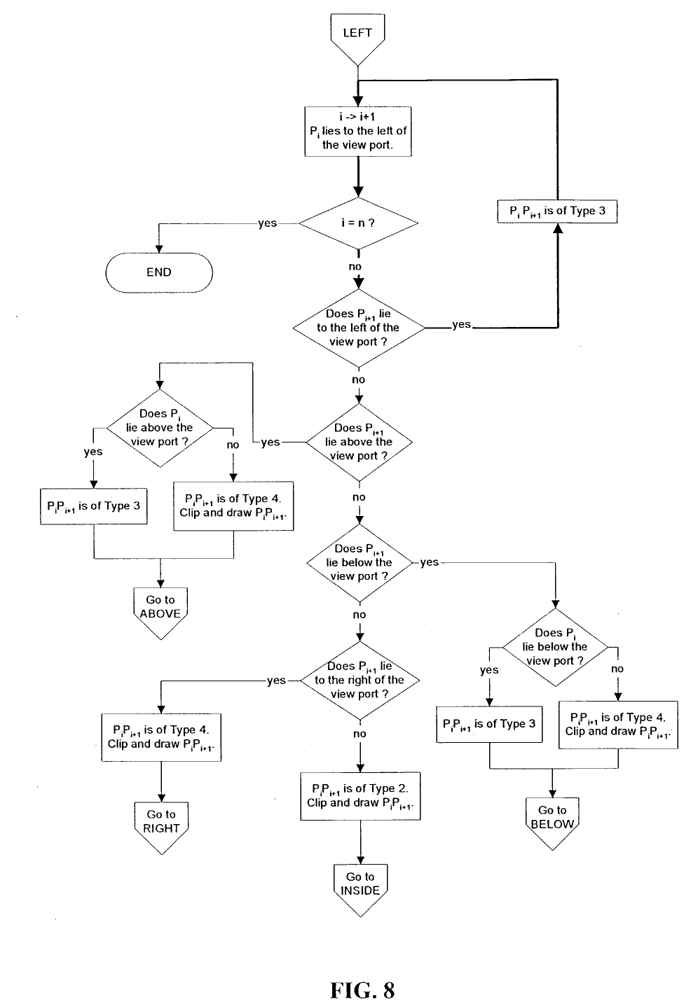

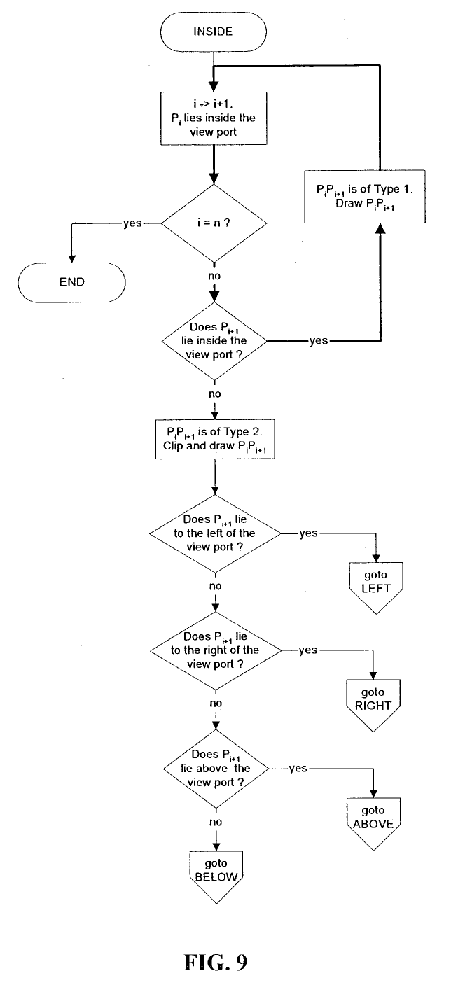

FIGS. 7-9 depict a flow chart showing details of a preferred algorithm for classifying and drawing line segments. The flow chart has been split into six parts, labeled BEGIN, LEFT, RIGHT, ABOVE, BELOW and INSIDE. Execution begins with the BEGIN part. Only the BEGIN, LEFT and INSIDE parts are shown. The RIGHT part, the ABOVE part and the BELOW part are similar to the LEFT part. The thick lines show the paths that are executed most often and therefore should be optimized.

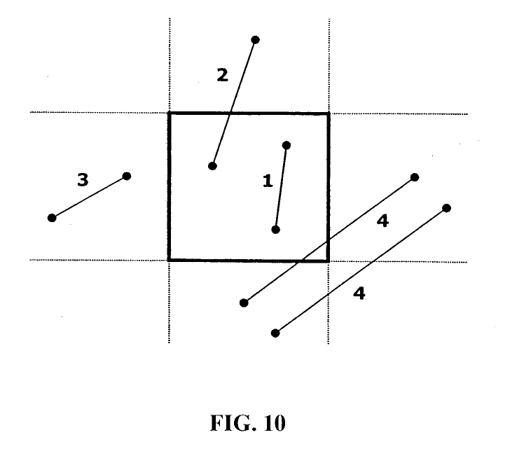

We now describe how the preferred poly-line rendering routine draws a line segment. When a line segment is drawn, only the part inside the view port is drawn. This is done as follows. First, the line segment is classified into one of the following four types, preferably by using the algorithm shown in FIGS. 7-9 (see FIG. 10 for graphical illustrations of the four line segment types):

1. Both end points lie inside the view port.

2. Exactly one end point lies inside the view port.

3. Both end points lie to the left of the view port, or both end points lie to the right of the view port, or both end points lie above the view port, or both end points lie below the view port.

4. Both end points lie outside the view port and the line segment is not of type 3.

This classification method has at least the following two advantages: (1) it is easy to classify line segments into these types; and (2) each type is either easy to handle or is relatively uncommon.

Types 1, 2, and 3 are straightforward and type 4 does not occur very often. [Note: We have tested the algorithm with real data (road maps) with more than 10,000 line segments. We rendered the maps at different scales and with different view ports. “We found” that there were usually at most 4 line segments of type 4 and never more than 8.] A line segment is processed for each type as follows:

1. Draw the line segment using a preferred BlueFuel line-drawing algorithm (described in Appendix B).

2. Draw the line segment using the preferred BlueFuel line-drawing algorithm with the following modification: start drawing from the end point inside the view port and keep drawing until a pixel outside the view port has been reached.

3. Do not do anything. The line segment does not intersect the view port.

4. This case requires more work than the others. Fortunately this case is rare (see the Note above), so its occurrence does not impact the overall efficiency of the algorithm. Initially, whether the line segment intersects the view port is undetermined. Let P and Q be the end points of the line segment. One method would be to find the intersection points R and S between the line segment PQ and the boundary of the view port. If there are such intersection points, then one only has to draw the line segment RS which is of type 1. We use a modified version of this scheme. We first locate the intersection point R that is closest to P. If there is such an intersection point, then we clip and draw the line segment RQ, which is of type 2.

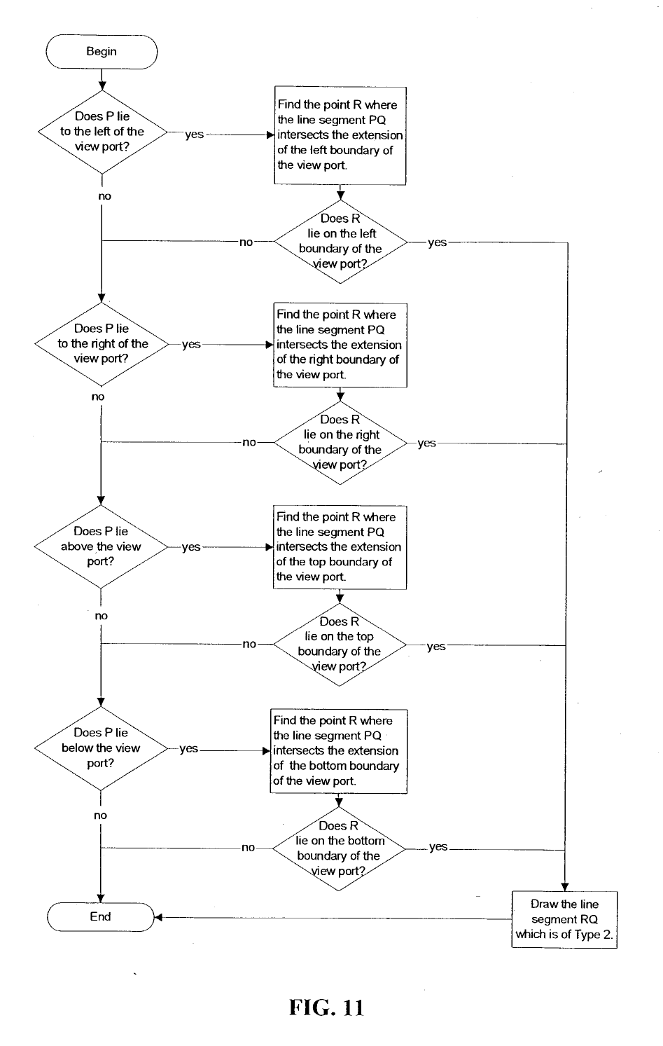

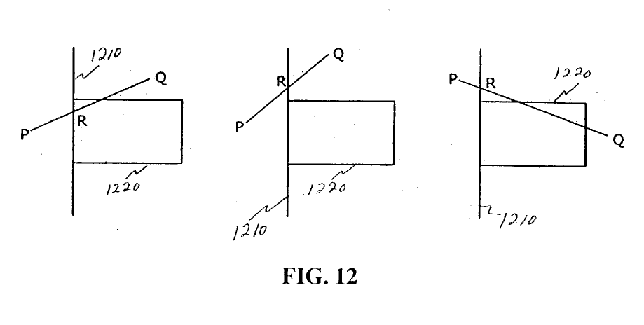

The precise details of the above preferred method applied to type 4 are given by the flow chart in FIG. 11. In the flow chart, the phrase “the extension of the left boundary of the view port” refers to the straight line obtained by extending the left boundary of the view port to a straight line and the phrase “lies to the left of the view poit” means lying to the left of said line. These ideas are graphically depicted in FIG. 12, discussed below.

Since line segments of type 4 are rare, a preferred embodiment does not optimize this algorithm. Double precision floating-point arithmetic may be used when calculating the intersection point R, with no impact on the overall efficiency of the program. FIG. 12 contains some illustrations of the algorithm in FIG. 11 for drawing a line segment PQ of type 4. The rectangle 1220 is the view port. The vertical line is the extension 1210 of the left boundary of the view port. The diagrams show different situations with P to the left of the view port but Q not to the left of the view port. (If Q did lie to the left, the line segment would be of type 3.) Hence the line segment PQ intersects the extension 1210 of the left boundary of the view port. We denote the intersection point by R. In the diagram on the left in FIG. 12, R lies on the left boundary of the view port and RQ is a line segment of type 2. In the middle and right diagrams, R does not lie on the left boundary of the view port.

Once the end points of the line segments have been established, the line segment, possibly clipped, is drawn. A novel line drawing algorithm for drawing lines on a two dimensional plane, which is optimized for the hand-held device environment, has been developed for this purpose and is described herein in Appendix B: The Line Drawing Algorithm.

Rendering the Text Layer

A preferred embodiment of the invention renders the text layer while drawing the street poly-lines. Whenever it finds a new poly-line, it identifies the first and the last vertices that are inside the view port. Then it picks the middle pair of vertices between them. The middle point of these two vertices is the point where the text block will anchor its center. Now, the corresponding font image for each character will be drawn on the allotted bit plane. Both the street poly-line layer and the text layer may be drawn in just one scan of the data without interfering each other.

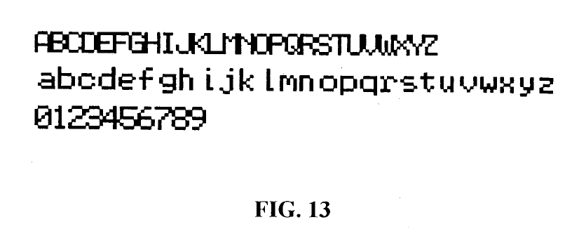

FIG. 13 shows the fonts used in one implementation of a preferred BlueFuel Map Rendering sub-system 120 for handheld phones. These images are generated by typing the letters with the text tool in PaintShop Pro software, then manually modified so that each letter occupies exactly the same space. The upper case letters and the digits are all in 5×7 size, while the lower case letters are all in 5×8 size. Finally, each row of the image was converted into a continuous bit-stream in order to reduce the file sizes.

Progressive Text Rendering

The main use of the text is to indicate the name of each street. As the number of streets shown on the screen varies, depending on the current zoom level, it is desirable to show only the names of important streets. For instance, only the names of major interstate highways should be displayed on a (zoomed-out) street map covering an entire city, and more and more street names should be displayed with progressive levels of zoom.

A preferred BlueFuel Map Rendering sub-system 120 implements this idea of Progressive Text Rendering by using a scoring system. All street segments have their own scores, and the preferred text rendering routine determines whether or not to display the name of the street at hand by comparing its score with a reference value determined by the current zoom level. In one embodiment, the score of each street is computed from its total length within the map. This, can be extended to a more sophisticated scoring scheme using other factors, including but not limited to street names, street density around an area, and others.

Text De-Cluttering

Even though the number of street names displayed using a preferred embodiment is reduced, it is still possible for the text strings to overlap each other. In order to avoid this, a 1-bit bitmap of the screen size is used to keep track of the occupancy of each pixel during the text rendering. Text is prevented from overlapping by having a preferred text rendering routine not render the current text if any of the pixels for the current text is already occupied by another text string. One disadvantage of this approach is the fact that it depends on the order of the street poly-line, in the data file. For example, it can happen that the name of an interstate highway is not drawn just because the name of another (shorter) local road is already occupying the space. In a preferred embodiment, this problem is avoided by sorting the street poly-lines according to their scores, so that the names of the streets with higher scores can be drawn first.

Landmark Overlays

To provide valuable data service along with maps, landmark overlay capability is useful. Landmarks can be the locations of businesses for a directory service, the locations of traffic incidents for a traffic information service, and so on.

Depending on the characteristics of the services, it could be highly desirable to make these landmarks interactive. For some map-based data services, the user might want to be able to select a particular landmark and to get more information about it.

As discussed above, a preferred BlueFuel Map Rendering sub-system 120 is based on multiple layers. By considering a set of landmarks as a layer, the landmarks can easily be rendered and maintained, as long as they contain properly transformed co-ordinate information.

Interactive landmarks are generally chosen as the top layers, so that they can be quickly redrawn as necessary without redrawing the whole map again. For example, when the user is browsing through the landmarks by repeatedly selecting next item, the screen is updated as quickly as possible, since in each view of the screen a different landmark is highlighted.

Navigation by Highlights

For interactive map-based data services, highlighting is a useful feature of software of a preferred embodiment. Drawing the selected landmark after drawing all other layers, and with a different color, can easily help to highlight a landmark. Corresponding data can be displayed in a designated portion of the screen (usually the bottom of the screen).

Highlighting streets can be problematic because of the complex nature of the poly-line drawing algorithm. However, it can be done by checking whether the next poly-line is the selected one, and if so, drawing it with a different color and displaying the name of the street on the designated portion of the screen. As the street layer is usually at the lowest layer, this scheme might not work well when there are many other items from higher layers. In such a case, a special algorithm to draw only one street may be used.

Alternatives

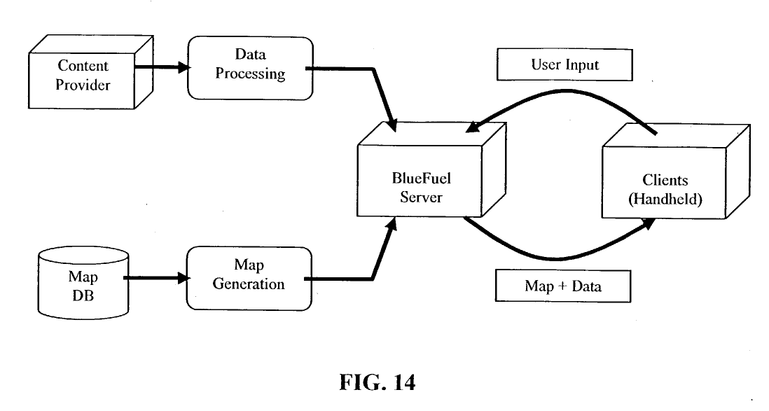

FIG. 14 shows overall structure of one implementation of the preferred BlueFuel Map system with an additional preferred Data Processing sub-system. The preferred Data Processing sub-system uses data from a content provider, such as a traffic information provider or a directory service provider. The content provider updates the data periodically and delivers it to a preferred Map Generation sub-system 110. The benefits of this separation of the content provider and the Map Generation sub-system 110 are that the content provider does not need to handle the possibly heavy traffic of data requests from the clients, and the Map Generation sub-system 110 has more flexibility to manage and upgrade the system.

In this implementation of the system, data from the content provider and map data are downloaded to handheld devices separately. It is the client device's responsibility to render the information when downloaded and present it in the desired manner to the user. In this way, the map data can be reused when different types of data are, available for the same geographic regions. Furthermore, since all the information delivered to the end user comes from the server, a preferred BlueFuel server can keep full control of its service. In other words, the server can add, delete, and modify the service contents easily without upgrading the client software.

Alternate Uses

As will be recognized by those skilled in the art, the methods and systems of the present invention described herein are not limited to the field of map transmission to handheld devices. The lossless compression methods described herein can be used in other contexts. The poly-line compression routine can be used to compress line data as part of a compression scheme for vector-based data that includes lines. Similarly, the text compression scheme can be used to compress any table of names. The vector-based line rendering routine can be used as a line drawing component of any vector-based rendering method.

While the embodiments shown and described herein are fully capable of achieving the objects of the subject invention, it is evident that numerous alternatives, modifications, and variations will be apparent to those skilled in the art in light of the foregoing description. These alternatives, modifications, and variations are within the scope of the subject invention, and it is to be understood that the embodiments described herein are shown only for the purpose of illustration and not for the purpose of limitation.

### Appendix A: Shapefiles

ESRI Shapefile Format

A Shapefile stores non-topological geometry and attribute information for the spatial features in a data set. The geometry for a feature is stored as a shape comprising a set of vector coordinates. Because Shapefiles do not have the processing overhead of a topological data structure, they have advantages (such as faster drawing speed and editability) over other data sources. Shapefiles handle a single feature that overlaps or is noncontiguous. They also typically require less disk space and are easier to read and write. Shapefiles can, support point, line, and area features. Area features are represented as closed loop, double-digitized polygons. Attributes preferably are held in a dBASE® format file. Each attribute record has a one-to-one relationship with an associated shape record.

An ESRI Shapefile consists of a main file (.shp), an index file (.shx), and a dBASE table (.dbf). The main file is a direct access, variable-record-length file in which each record describes a shape with a list of its vertices. In the index file, each record contains the offset of the corresponding main file record from the beginning of the main file. The dBASE table contains feature attributes with one record per feature. The one-to-one relationship between geometry and attributes is based on record number. Attribute records in the dBASE file must be in the same order as records in the main file.

Another advantage of using ESRI Shapefile is its popularity. There are many freely available Shapefile I/O libraries and utilities, and most 615 data vendors, including the US government and its agencies, provide map data in this format.

Organization of Main File

TABLE 2
Organization of the main file.
File Header

| | |
|---|---|
| Record Header | Record Contents |
| Record Header | Record Contents |
| Record Header | Record Contents |
| . . . | |
| . . . | |
| Record Header | Record Contents |

Table 2 shows the organization of the main file. The main file header is 100 bytes long. Table 3 shows the fields in the file header with their byte position, value, type, and byte order. In the table, position is given with respect to the start of the file.

TABLE 3
Description of the file header.

| Position | Field | Value | Type | Byte Order |
|---|---|---|---|---|
| Byte 0 | File Code | 9994 | Integer | Big |
| Byte 4 | Unused | 0 | Integer | Big |
| Byte 8 | Unused | 0 | Integer | Big |
| Byte 12 | Unused | 0 | Integer | Big |
| Byte 16 | Unused | 0 | Integer | Big |
| Byte 20 | Unused | 0 | Integer | Big |
| Byte 24 | File Length | File Length | Integer | Big |
| Byte 28 | Version | 1000 | Integer | Little |
| Byte 32 | Shape Type | Shape Type | Integer | Little |
| Byte 36 | Bounding Box | Xmin | Double | Little |
| Byte 44 | Bounding Box | Ymin | Double | Little |
| Byte 52 | Bounding Box | Xmax | Double | Little |
| Byte 60 | Bounding Box | Ymax | Double | Little |
| Byte 68 | Bounding Box | Zmin | Double | Little |
| Byte 76 | Bounding Box | Zmin | Double | Little |
| Byte 84 | Bounding Box | Mmin | Double | Little |
| Byte 92 | Bounding Box | Mmax | Double | Little |

Field “Shape Type” specifies which kind of shape is contained in this file. In the preferred BlueFuel Map system, the shape is poly-line, and the corresponding “Shape Type” is 3.

The header for each record stores the record number and the content length for the record. Record header has a fixed length of 8 bytes. Table 4 shows the fields in the file header with their byte position, value, type, and byte order. In the table, position is with respect to the start of record.

TABLE 4
Description of main file record header.

| Position | Field | Value | Type | Byte Order |
|---|---|---|---|---|
| Byte 0 | Record | Record | Integer | Big |
| | Number | Number | | |
| Byte 4 | Content Length | Content Length | Integer | Big |

A Shapefile record content consists of a shape type followed by the geometric data for the shape. In our case the shape is poly-line. Table shows the record contents.

TABLE 5
Poly-line record contents.

| | | | | | Byte |
|---|---|---|---|---|---|
| Position | Field | Value | Type | Number | Order |
| Byte 0 | Shape Type | 3 | Integer | 1 | Little |
| Byte 4 | Box | Box | Double | 4 | Little |
| Byte 36 | NumParts | NumParts | Integer | 1 | Little |
| Byte 40 | NumPoints | NumPoints | Integer | 1 | Little |
| Byte 44 | Parts | Parts | Integer | NumParts | Little |
| Byte X | Points | Points | Point | NumPoints | Little |

Note:
X = 44 + 4*NumParts

Organization of the Index File

The index file (.shx) contains a 100-byte header followed by 8-byte, fixed-length records. Table 6 illustrates the index file organization.

TABLE 6
Organization of the index file.
File Header
Record
Record
. . .
. . .
Record

The index file header is identical in organization to the main file header described above. The file length stored in the index file header is the total length of the index file in 16-bit Words (the fifty 16-bit words of the header plus 4 times the number of records).

The i^{th} record in the index file stores the offset and content length for the i^{th} record in the main file. Table 7 shows the fields in the file header with their byte position, value, and type and byte order. In the table, position is with respect to the start of the index file record.

TABLE 7
Description of index records.

| | | | | Byte |
|---|---|---|---|---|
| Position | Field | Value | Type | Order |
| Byte 0 | Offset | Offset | Integer | Big |
| Byte 4 | Content Length | Content Length | Integer | Big |

Organization of the dBASE File

The dBASE file (.dbf) contains any desired feature attributes or attribute keys to which other tables can be joined. Its format is a standard DBF file used by many table-based applications in Windows™ and DOS. Any set of fields can be present in the table. There are four requirements, as follows:

1. The file name must have the same prefix as the shape and index file. Its suffix must be .dbf.

2. The table must contain one record per shape feature.

3. The record order must be the same as the order of shape features in the main (*.shp) file.

4. The year value in the dBASE header must be the year since 1900.

For details on ESRI Shapefile format, see the PDF document entitled “ESRI Shapefile Technical Description”, ESRI White Paper, July 1998. This paper can be found on the Internet at: http://www.esri.com/library/whitepapers/pdfs/shapefile.pdf.

Shapefile Utilities

In this section, we list some useful libraries and utilities for handling ESRI Shapefile formats.

ShapeLib

Shapelib is a free C library for reading and writing ESRI Shapefiles. It is available in source form, with no licensing restrictions.

It also includes command line utilities for viewing (as text) the contents of Shapefiles, for clipping, shifting, and scaling shapes, and for re-projecting shapes.

Visit http://gdal.velocet.ca/projects/shapelib/ for more information.

ShapeUtil

This is an example program bundled in ShapeLib, which turns out to be very useful for performing various tasks on ESRI Shapefiles, such as collecting only the shape records whose values of the specified numeric attribute field are in the provided list of numbers.

In one embodiment of the subject invention, this program is modified to provide such a query also on the string attribute fields.

Refer to the usage screen when you launch the program without any arguments for more details.

ESRI ARC Explorer

ESRI offers a free viewer of Shapefiles, called ESRI ARC Explorer.

It provides many different ways to examine the Shapefile, as well as simple query capabilities.

This is a very useful tool to visually examine the data before and after processing.

Visit http://www.esri.com/software/arcexplorer/index.html for more information.

MapBrowser

This is another freely available ESRI Shapefile viewer.

This application shows the shape graphically in the top half of the screen and the .dbf table in a view resembling a spreadsheet in the bottom half of the screen. Because of this unique display method, it's more useful than ESRI ARC Explorer for some tasks.

Visit http://www.vdstech.com/mapbrowser.htm for more information.

TIGER® 2000 Database

The U.S. Census Bureau periodically publishes its census result data along with comprehensive TIGER® (Topologically Integrated Geographic Encoding and Referencing) database to the public.

Furthermore, ESRI converts this data into Shapefile format and distributes it freely. Even though it does not contain up-to-date map data, it may be used when being up-to-date is not crucial.

The Redistricting TIGER® 2000/Line Shapefiles contain data about the following features:

Line Features—roads, railroads, hydrography, and transportation and utility lines.

Boundary Features—statistical (e.g., census tracts and blocks); government: (e.g., places and counties) and administrative (e.g., congressional and school districts).

Landmark Features—point (e.g., schools and churches); area (e.g., parks and cemeteries) and key geographic locations (e.g., apartment buildings and factories).

Visit the following sites for more information:

http://www.geographynetwork.com/data/tiger2000/

http://www.census.gov/geo/www/tiger/tiger2k/tgr2000.html

http://www.census.gov/geo/www/tiger/rd_{—}2ktiger/tgrrd2k.pdf

As the original TIGER® 2000 database is composed of just text files, the Shapefile version is more useful for most of the cases. Nevertheless, the Shapefile version does not contain all the information the original TIGER® 2000 database provides, more often than not, it is necessary to refer to the original text format data for some information. For example, the Shapefile version of TIGER® 2000 data contain only one primary name for each street segment even though the original TIGER® 2000 data contain all the alternate names a street segment has. In order to collect all poly-lines corresponding to a particular street name, one has to refer to the original TIGER® 2000 data instead of the Shapefile version.

### Appendix B: The Line Drawing Algorithm

Line Segments in Vector Graphics Images

Let P and Q be two pixels in an image. Let (x₁, y₁) be the coordinates of P and (x₂, y₂) be the coordinates of Q. Thus x₁, y₁, x₂, and y₂ are integers. The mathematical line from P to Q consists of all points (x, y) with x and y real numbers such that x lies between x₁ and x₂ and

y=y₁+k(x−x₁) where k=(y₂−y₁)/(x₂−x₁).

The line can also be described as the set of all points (x, y) with y between y₁ and y₂ and

x=x₁+k(y−y₁) where k=(x₂−x₁)/(y₂−y₁).

When drawing a line segment in a vector graphics image, this description has to be modified, for pixels have integer coordinates. The following is one way of drawing a line:

If |x₁−x₂|≧|y₁−y₂|, then we draw all pixels with coordinates (x, y) such that x is an integer between x₁ and x₂, and

y=round(y₁+k(x−x₁)) where k=(y₂−y₁)/(x₂−x₁).

(Here round (x) means the real number x rounded off to the nearest integer.)

If |x₁-x₂|<|y₁−y₂|, then we draw all pixels with coordinates (x, y) such that y is an integer between y₁ and y₂, and

x=round(x₁+k(y−y₁)) where k=(x₂−x₁)/(y₂−y₁).

All arithmetic may be carried out with floating point numbers. The following pseudo C code implements the algorithm:

int x;
double y,k;
if (abs(x₂−x₁)>=abs(y₂−y₁)) {

if (y1==y₂)

if (x₁<=x₂)

for (x=x₁;x<x₂;x++)

draw the pixel (x,y₁);

else

similar case

else

if (x₁<x₂) {

k = (double) (y₂−y₁) / (double) (x₂−x₁);
y = (double) y₁ + 0.5;
for (x=x₁;x<=x₂;x++) {

draw the pixel (x, floor (y) );
y + = k;

}

}
else {

similar case

}

}

else {

similar cases

}
(Note that the denominator in the quotient that defines k is never zero.)

The Bresenham Algorithm for Drawing Line Segments

In many applications we need a more efficient algorithm. Such an algorithm should rely on integer arithmetic instead of floating point arithmetic. A commonly used algorithm is the Bresenham algorithm (see J. E. Bresenham, “Algorithm for computer control of digital plotter”, IBM Systems Journal 4 (No.1), January 1965, 25-30.). This algorithm has the following properties:

Efficient. Each pixel requires one or two increments, one or two integer additions, and two tests.

Exact. The algorithm produces a line segment that is exactly the line segment produced by the floating-point algorithm described above.

However, as will be recognized by those skilled in the art, there are more efficient algorithms that Bresenham, and the subject invention is not limited to that algorithm (see below).

The BlueFuel Algorithm for Drawing Line Segments

In this section we describe a preferred BlueFuel algorithm for drawing line segments. This algorithm is more efficient than the Bresenham algorithm. In the following discussion it is assumed that arithmetic is performed using 32-bit integers. Arithmetic could also be performed using 64-bit integers, 128-bit integers, etc., in which case the details of the method described below would be correspondingly modified, as will be clear to those skilled in the art.

The BlueFuel algorithm has the following properties:

Very efficient. Each pixel requires one increment, one addition, one shift and one test. (There are also a few more operations per line segment.)

Not exact. There are rounding off errors. Thus the algorithm produces line segments that differ from the line segments produced by the floating-point algorithm described above.

The rounding-off errors are insignificant if the image width and height are at most 32768 (=2¹⁵).

That the rounding-off errors are insignificant means the following:

No pixel will be off more than one pixel from the position given by the floating-point algorithm described above.

The end points of the line segment will be correctly positioned.

The last condition is significant. If the end points were incorrectly positioned and the correct positions were near the boundary of the image, then the algorithm could attempt to draw pixels outside the image. A computer program that implements the algorithm might then write image data to a memory location outside the image buffer. This would result in undefined behavior, and would most likely cause the program to crash. This does not happen if the image width and height are at most 2¹⁵.

One idea behind the BlueFuel algorithm is to do calculations with an accuracy of 2⁻¹⁶. Thus we used fixed-point arithmetic with 16 integer bits and 16 fractional bits. If 64-bit integer arithmetic were used, calculations would need to be performed with an, accuracy of 2⁻³², and if 128-bit integer arithmetic were used, calculations would need to be performed with an accuracy of 2⁻⁶⁴.

Preferred code follows:

int x,y,k;
if(abs(x₂−x₁)> = abs (y₂−y₁)) {

if (y₁==y₂)

if (x₁<=x₂)

for (x=x₁;x<=x₂;x++)

draw the pixel (x,y₁);

else

similar case

else

if(x₁<=x₂) {

k = ((y₂−y₁)<<16) / (x₂−x₁);
y = (y₁<<16) + (1<<15);
for (x=x₁;x<=x₂;x++) {

draw the pixel (x, y>>16);
y + = k;

}

}

else {

similar case

}

}

else {

similar cases

}

This is the preferred BlueFuel algorithm. (Note that the denominator in the quotient that defines k is never zero.)

Our claims about the accuracy of the algorithm can be verified as follows: If we compare the BlueFuel algorithm with the floating point algorithm we see that k has been rounded off in the BlueFuel algorithm. This introduces an error of magnitude less than 1 in y. This error gets accumulated in the loop when we increment y. Consider now what happens when we reach the last pixel, the one where x has the value x₂. Then total error in y will be less than x₂−x₁ which is less than the width of the image, which is required to be at most 2¹⁵. If there were no rounding off errors, then y would have the value 2¹⁶y₂+2¹⁵. With rounding off errors y will take a value in the range from 2¹⁶y₂+1 to 2¹⁶y₂+2¹⁶−1. Hence y>>16 will still have the correct value y₂. The last pixel drawn will have coordinates (x₂, y₂) as desired.

These conclusions hold even if we allow negative coordinates. This relies on the fact that in the C programming language x>>16 always evaluates to the value of x divided by 2¹⁶ rounded off downward to the nearest integer. For instance, (−1)>>16 evaluates to −1.

Efficiency Comparison of BlueFuel and Bresenham

We wrote a program in C that does the following. First an image buffer of 128×128 pixels is allocated. Then a list of 1000 random pairs of initial points and end points is generated. Finally the corresponding list of 1000 lines is drawn 10,000 times using BlueFuel and 10,000 times using Bresenham. This program was executed on a PC with a 600 MHz Pentium II processor. We got the following timings:

| | |
|---|---|
| Blue Fuel: | 5908 ms |
| Bresenham: | 7550 ms |

Thus the BlueFuel algorithm was 21% faster than the Bresenham algorithm.

### Appendix C: Lossy Simplification Procedures

Classifying Nodes A map is a two-dimensional data set, which consists of poly-lines and nodes that segment the poly-lines into smaller pieces, called road segments. There are no isolated: poly-lines in this data set. That is, each poly-line has to intersect with at least one other poly-line, and the intersection has to be a node on one of the poly-lines.

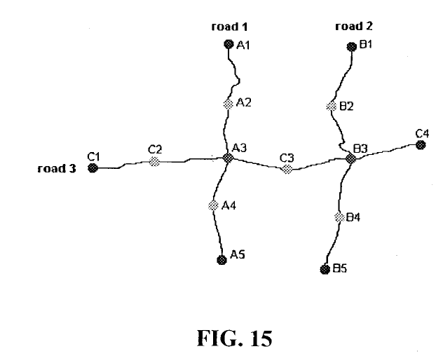

We classify the nodes into three categories, according to their topological features: Junction Nodes, End Nodes and Shape Nodes. Shown in FIG. 15 are three poly-lines, which represent three different roads. We define the starting and ending nodes as End Nodes, including A1, A5, B1, B5, C1 and C4, since they are the starting and ending points of the total map network. We define the intersection nodes as Junction Nodes, including A3, and B3. We define the other nodes as Shape Nodes, including C2, C3, A2, A4, B2 and B4.

A map data set is defined in a one-dimensional dBASE file. The dBASE file is organized in records. Each record describes a poly-line part between two nodes. It contains, among other attributes: an identifier for the current poly-line part, two ending node identifiers of the current poly-line part, a road name, and a road type.

We will use FIG. 15 to illustrate how to extract topology information from these records. Node A3 is a Junction Node, since it's the intersection of road segments C₂A₃, A₃C₃, A₂A₃ and A₃A₄, therefore, it will exist in those four records. Node A₁, an Ending Node, will exist only in the record corresponding to segment A₁A₂. Node A₂, a Shape Node, will exist in the two records corresponding to segments A₁A₂ and A₂A₃, and these two records share the same road name and road type.

Below is preferred pseudo-code for classifying nodes:

For i=1 to N (N=Records number in the dBASE file)

Read two ending node id in the ith record

if the node id is new

Create a new Node Object

else

Append the road name & road type into this Node Object

Increase the roads number of this Node Object by one

End

Merging Road Segments

Each road segment corresponds to a record in a dBASE file and a series of vertices in a main file. We can simplify it by reducing some vertices according to some criteria. However, we note that we can improve simplifying efficiency by merging some road segments into one. For example, in FIG. 15, road segments A₃A₄ and A₄A₅ can be merged before they are simplified, since they belong to the same road and have the same feature attributes. In this case, road segments A₃A₄ and A₄A₅ are merged into a new road segment A₃A₅. After simplification, there are only three vertices, at A₃, A₄, and A₅. In this example, even if we simplify A₃A₄ and A₄A₅ independently, we would still achieve the same result. But if A₃A₄ and A₄A₅ were segmented into 50 parts each, and we simplified it before merging all these segments, we would get around 100 vertices.

Then, should one go a step further and merge all road segments of road 1 in FIG. 15 into one segment? Keeping in mind the goal of maintaining the topological and features attributes and only modifying the geometrical attributes, this is not advisable. If we merge all segments of a road into one segment, then simplify it, the Junction Node may be thrown away, as the result of poly-line simplification. Then the topology attributes of the map are changed. So merging preferably only applies to those road segments linked by a Shape Node.

Below is preferred pseudo-code for Merging Road Segments:

ni: the ith Shape Node, which links two road segments s1 and s2. It corresponds to vertex vi

s1: the segment linked by Shape Node vi, which has ending nodes na and ni. na and ni correspond to vertices va and vi. And s1's id is sid1.

s2: the segment linked by Shape Node vi, which has ending nodes ni and nb. ni and nb correspond to vertices vi and vb. And s2's id is sid2.

For j=1 to N (N is the total number of Shape. Nodes)

For ith Shape Node vi, extract vertex strings from its linked road segments s1 and s2;

Concatenate the two vertex string into one such that this new vertex string has va and vb as its two ending node vertices;

Merge the records corresponding to road segments s1 and s2 into one new record; the new record takes sid1 as its new road segment id;

Delete the old two segments;

Iterate all the other nodes (include Junction Nodes, Shape Nodes and End Nodes), and for any node which takes sid2, update sid2 to sid1;

End

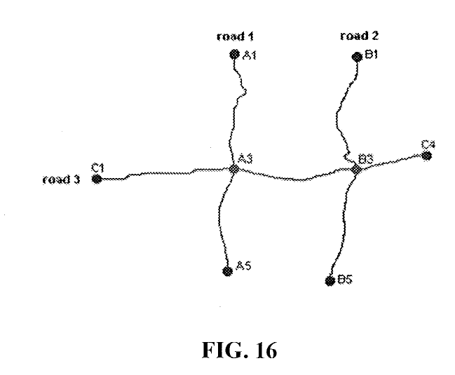

Compared with the map shown in FIG. 15, the map shown in FIG. 16 only contains Junction Nodes and End Nodes. In the map shown in FIG. 16, all segments between any two adjacent Junction Nodes are merged into one segment, and all Shape Nodes are removed. Changes happen on two fronts: (1) the vertices defined in the main file do not change except that segments merged into one segment have their vertices reorganized into one segment's vertices; and (2) in a dBASE file, the number of records is reduced such that, for those segments merged into one segment, their corresponding records are all deleted and replaced by one new segment record representing the new segment.

Simplifying Road Segments

The road segment corresponds to a poly-line that is composed of a series of vertices. A preferred embodiment uses the Douglas-Peucker algorithm (discussed above) to do poly-line simplification.

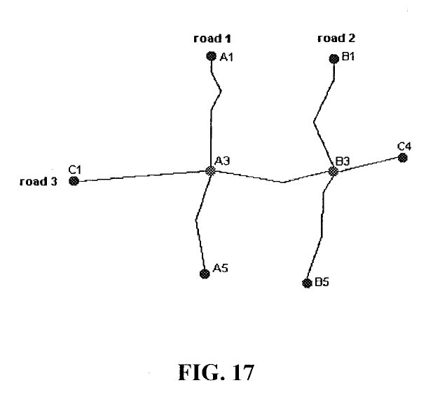

Compared with the map in FIG. 16, the map in FIG. 17 throws away some details while still maintaining the main structure. Features attributes of the road are not changed, but geometrical attributes are changed, in that some vertices are thrown away due to poly-line simplification.

What is claimed is:

1. A method for transmitting map data, comprising:
receiving unprocessed vector formatted map data regarding a selected geographical region;
layering said received map data;
simplifying said layered map data; and
transmitting some or all of said simplified data to a remote device.

2. A method as in claim 1, further comprising packing at least some of said simplified data.

3. A method as in claim 1, further comprising compressing at least some of said simplified data.

4. A method as in claim 1, wherein a first portion of said simplified data is transmitted at a first time, and further comprising transmitting a second portion of said simplified data at a second time.

5. A method as in claim 1, wherein said step of layering said stored map data comprises layering said stored map data into a base layer and one or more detail layers.

6. A method as in claim 1, wherein said step of simplifying said layered map data comprises lossy simplification.

7. A method as in claim 1, wherein said step of simplifying said layered map data comprises lossless simplification.

8. A method as in claim 7, wherein said lossless simplification comprises poly-line grouping.

9. A method as in claim 7, wherein said lossless simplification comprises name processing.

10. A method as in claim 3, wherein said step of compressing comprises compression of poly-lines.

11. A method as in claim 3, wherein said step of compressing comprises compression of names.

12. A method as in claim 6, wherein said lossy simplification comprises preservation of topological and features attributes and modification of geometrical attributes.

13. A method as in claim 6, wherein said lossy simplification comprises poly-line simplification.

14. A method as in claim 13, wherein said poly-line simplification comprises a Douglas-Peucker algorithm.

15. A method as in claim 3, wherein said step of compressing said simplified data comprises text compression.

16. A method as in claim 15, wherein said text compression comprises a Lempel-Ziv text compression algorithm.

17. A method for displaying map data, comprising:
receiving compressed, layered, vector formatted map data regarding a selected geographic region;
decompressing said received data; and
rendering said decompressed data on a display device, wherein said rendering comprises multi-layer rendering.

18. A method as in claim 17, wherein said step of decompressing comprises decompression of poly-lines.

19. A method as in claim 17, further comprising:
subsequently receiving additional compressed, layered, vector formatted data regarding said selected geographical region
decompressing said subsequently received additional data; and
rendering said decompressed subsequently received additional data on said display device, wherein said rendering comprises multi-layer rendering.

20. A method as in claim 17, wherein said step of decompressing comprises decompression of names.

21. A method as in claim 17, wherein said step of rendering comprises vector-based poly-line rendering.

22. A method as in claim 17, wherein said multi-layer rendering comprises rendering text and poly-lines simultaneously.

23. A method as in claim 17, wherein said map data comprises poly-line data corresponding to poly-lines comprised of line segments and wherein said multi-layer rendering comprises classifying said line segments into four types.

24. A method as in claim 17, wherein said rendering comprises progressive text rendering based on a scoring system.

25. A method as in claim 17, wherein said rendering comprises text de-cluttering.

26. A method as in claim 25, wherein said text de-cluttering is based on a scoring system.

27. A system for processing and displaying map data, comprising:
a map database;
a map generation sub-system in communication with said map database;
a map rendering sub-system in communication with said map generation sub-system; and
a display device storing software comprising said map rendering sub-system;
wherein said map generation sub-system performs map data selection, map data layering, and map data simplification.

28. A system as in claim 27, wherein said map generation sub-system performs map data compression.

29. A system as in claim 27, wherein said map rendering sub-system performs multi-layer rendering.

30. A system as in claim 27, wherein said map data simplification comprises lossy simplification and lossless simplification.

31. A system as in claim 27, wherein said map rendering sub-system performs progressive text rendering based on a scoring system.

32. A system as in claim 27, wherein said map rendering sub-system performs text de-cluttering.

33. A method for rendering line segments on a pixel display, comprising:
performing calculations using m-bit integers, where m is an even integer and m is greater than or equal to 32; and
for a line segment from a first endpoint to a second endpoint:
rounding off the slope of the line segment to 2^{-m/2} precision; and
calculating pixel locations corresponding to points between and including said first and second endpoints based on said rounded off slope, wherein a unique pixel location corresponding to said second endpoint has the same location it would have had if said slope had not been rounded off.

34. A method as in claim 33, wherein said pixel display is not more than 2^{m/2-1} pixels wide.
